(19) United States
(12) Patent Application Publication
(10) Pub. No.: US 2012/0318113 A1
(43) Pub. Date: Dec. 20, 2012

(54) Optical Aid for Power Tools

(76) Inventor: Dan Coble, Vanzant, MO (US)

(21) Appl. No.: 13/495,917

(22) Filed: Jun. 13, 2012

Related U.S. Application Data
(60) Provisional application No. 61/498,851, filed on Jun. 20, 2011.

(51) Int. Cl. B26D 7/00; B23Q 17/24; B23P 6/00

(52) U.S. Cl. 83/521; 29/402.08; 29/407.04

(57) ABSTRACT

An optical aid that improves the precision of cuts made by power tools by using reflecting surfaces to project an image of the cutting surface to the operator.

### CROSS REFERENCE TO RELATED APPLICATION(S)

This Application claims the benefit of U.S. Provisional Patent Application Ser. No. 61/498,851, filed Jun. 20, 2011, the entire disclosure of which is incorporated herein by reference.

### BACKGROUND OF THE INVENTION

1. Field of the Invention

This disclosure relates to the field of accessories for hand and power tools. In particular, to the use of an optical aid to improve the precision of cuts made by such tools.

2. Description of the Related Art

Woodworking is an ancient and time-honored art, older than written language. Historians have determined that early development of human civilizations was closely related to technological advances in working materials such as wood. While the tools used to craft wood have changed over time, they all serve the same basic purpose: cutting and shaping the material to the desired final form. Modern power tools achieve degrees of safety, precision, and accuracy that hand tools generally cannot.

However, power tools are not without their own limitations. While power tools offer stability and consistent application of force, they also present design challenges. For example, battery-operated tools draw significant power and require heavy batteries which must be recharged frequently. Tools that plug into wall receptacles are confined to locations with access to power and must be engineered so that the power cable is directed away from the path of the cutting surface. Additionally, because the force applied by power tools is very high, power tools present risks of severe injury that hand tools do not. For example, a woodworker with a mallet and chisel or handsaw is very unlikely to sever his hand or fingers, but a circular saw easily poses that risk.

This risk is often mitigated by interposing a barrier between the cutting surface and the operator, but such barriers also present problems. For example, barriers made of resilient materials, such as metals and metal alloys, tend to be opaque, obscuring the cutting surface from view. This means that even as the safety features protect the operator, the tool loses some of its precision and accuracy because the operator can no longer directly observe the cutting surface. If, however, the barrier is made of transparent materials, such as plastics, the barrier is generally less rugged, provides less protection, and is susceptible to shattering, splintering, or cracking, which itself poses additional safety risks to the operator.

Similarly, certain power tools would be well suited to certain types of woodworking tasks, except that the design of the tool inhibits the ability of the operator to directly observe the cutting surface. For example, a typical wood router is designed for creating functional or decorative edges to wood boards. The wood router includes a router bit located in the middle of a circular base, the lateral edges of the bit have cutting surfaces, and the motor spins the bit to produce a lateral cutting action. The operator then moves the router along the edge of the work piece to apply the edge. In so doing, the operator generally need not actually see the router bit itself, he need only know that the router is moving in a straight line along the edge of the board, and this can be accomplished by clamping a straight-edge or guide to the work piece at the proper distance from the edge to be cut.

Routers also sometimes have “plunge” modes, where the bit has a ventral cutting surface and the router is placed on a flat surface of the work piece and the bit is lowered into the work piece to bore a hole, such as for accepting a dowel rod.

Although the router is also suitable for tasks such as engraving, the inability to see the router bit prevents the operator from using the router in such free-form applications. Even if the operator could see the bit, the motor housing is located directly above the bit and the shadow of the motor housing obscures the bit, making it difficult for the operator to follow a guide pattern or template precisely.

As a consequence, woodworkers often make custom jigs or templates to control the movement of the tool for shaped cuts. These jigs are essentially wooden templates with a channel for the router bit shaped like the desired cut. The jig is clamped to the work piece and the router bit is moved along the channel to produce the desired cut. Making the jig itself takes time and consumes materials and usually is only worth the woodworker's effort if the template will be reused to reproduce the cut on future projects. For example, it would be a waste of time to build an engraving jig for a wood router which carves a person's name into the work piece, as the woodworker is almost certain to never need to carve that specific name again. Also, making the jig often requires that the woodworker use other tools because of the above limitations. Further, certain types of engraving simply are not possible using a jig. Where the engraving includes a closed shape, such as the letters “0,” “D,” and “P,” when the channel is cut in the shape of the letter, the center of the closed portion of the shape will no longer be attached to the template and will simply fall out of the jig. The resulting jig would have a wide opening, for example, in the head of the “P” which would permit the router bit to wander off track.

Woodworkers thus have little choice but to purchase multiple tools that essentially serve the same function, except that the designs of the tools differ in order to facilitate a particular use. For example, the Dremel™ rotary tool is little more than a miniaturized hand-held router with no base plate, allowing the operator to see the cutting surface and grip the device for engraving and other free-form work. However, the absence of a base in a Dremel™ tool also reduces its overall stability and causes the bit to more easily jump and skip across the surface of the work piece. Woodworkers thus must own, maintain and sharpen a variety of toolbits, battery packs, and accessories, not all of which are interchangeable and all of which present inherent obstacles to performing certain types of work. Additionally, woodworkers must haul these tools from site to site, requiring additional storage and hassle, and increased risk of loss, theft, or breakage.

### SUMMARY

The following is a summary of the invention which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, described herein, among other things, is an optical aid for use with a power tool. The optical aid generally includes one or more reflective surfaces to reflect the cutting surface of the power tool to the operator, improving the precision and accuracy of cuts and allowing the power tool to be used in ways not otherwise feasible because the design of the power tool obstructs the operator's view of the cutting surface when the operator uses the power tool in a natural or comfortable posture or position. The optical aid can attach directly to the power tool, such by attaching to the power tool's existing components, or the optical aid may be engineered to attach to the power tool by replacing an existing component.

Described herein, among other things, is an optical aid for a power tool comprising: a power tool having a cutting surface; an optical aid including a base configured for attaching to the power tool, a bracket attached to the base, and one or more mirrors disposed on the bracket such that the one or more mirrors reflect to the operator of the power tool an image of the cutting surface.

In an embodiment, the optical aid further includes a light source attached to the bracket and illuminating the cutting surface.

In an embodiment, one or more of the one or more mirrors magnifies the reflected image.

In an embodiment, the base attaches to an existing base of the power tool.

In an embodiment, the base replaces an existing base of the power tool.

Also described herein, among other things, is a method for making a power tool having an optical aid, the method comprising: providing a power tool having a cutting surface and an existing base plate; providing a new base plate configured for attaching to the power tool, the new base plate including a bracket attached to the new base plate, one or more mirrors disposed on the bracket such that when the new base plate is attached to the power tool, the one or more mirrors reflect to the operator of the power tool an image of the cutting surface; replacing the existing base plate with the new base plate; making a power tool having an optical aid.

In an embodiment of the method, the method further comprises: providing a light source attached to the new base plate; illuminating the cutting surface with the light source.

In an embodiment of the method, one or more of the one or more mirrors magnifies the reflected image.

Also described herein, among other things, is a method for viewing the cutting surface of a power tool, the method comprising: providing a power tool having a cutting surface; providing an optical aid for the power tool having one or more mirrors reflecting to the operator of the power tool an image of the cutting surface; attaching the optical aid to the power tool; viewing the cutting surface in one or more of the one or more mirrors.

In an embodiment of the method, the method further comprises: the providing an optical aid further comprising a light source; illuminating the cutting surface with the light source.

### BRIEF DESCRIPTION OF THE DRAWINGS

FIG. 1 is a perspective view of an exemplary embodiment of the present invention in use from one angle.

FIG. 2 is a prospective view of an exemplary embodiment of the present invention in use from another angle.

FIG. 3 is a cross-sectional view of an exemplary embodiment of the present invention from the prospective of line 4-4 of FIG. 2.

FIG. 4 is an exploded view of an exemplary embodiment of the present invention with fastener components intentionally omitted for clarity.

### DESCRIPTION OF PREFERRED EMBODIMENT(S)

Although the present invention is described with particular reference to the accompanying drawings, it is to be understood at the outset that it is contemplated that the present invention may vary in specific detail from that illustrated and described herein while still achieving the desirable characteristics and features of the present invention. Accordingly, the description that follows is intended to be understood as a broad enabling disclosure directed to persons skilled in the applicable arts, and is not to be understood as being restrictive.

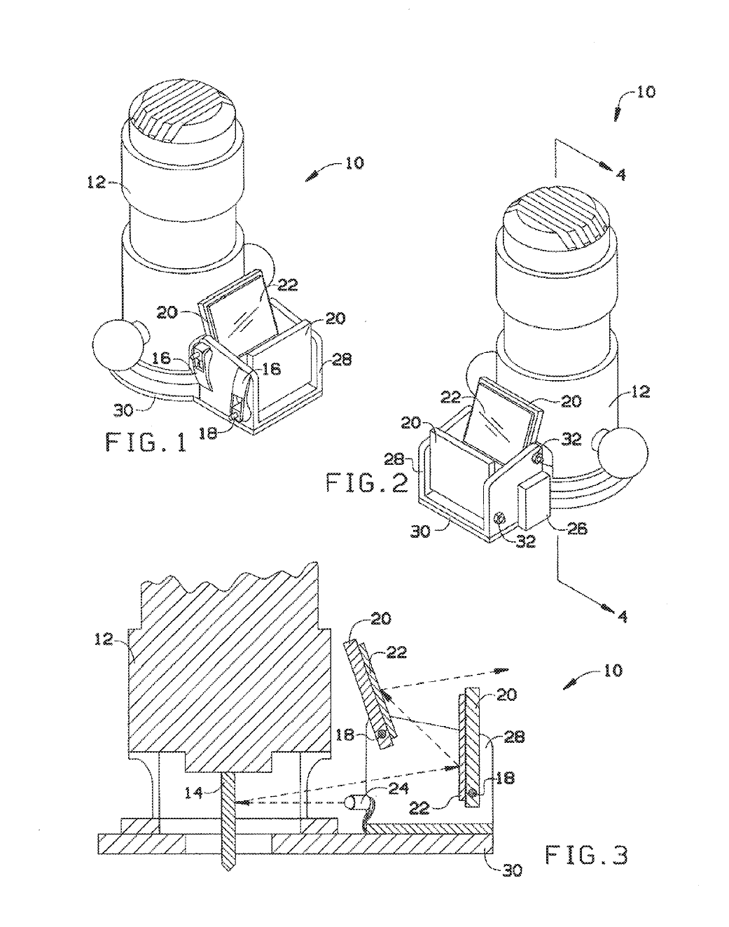

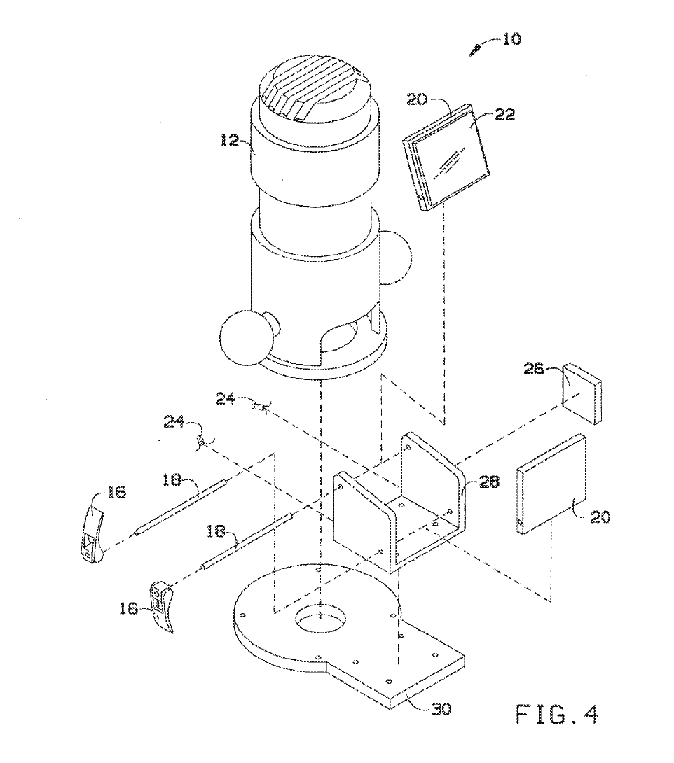

In the embodiment depicted in FIG. 1, the optical aid (10) is suitable for use with a wood router (12) and is configured for attaching to a wood router (12). The depicted optical aid (10) includes a base (30), a bracket (18), and two mirrors (22) affixed to metal plates (20) that are attached to the bracket (18) by hardware (16, 18, 32). Because the present optical aid is intended for use with any power tool (12) where the design of the tool (12) impedes the operator's full view of the cutting surface (14), the specific configuration of the optical aid (10) will vary from embodiment to embodiment. In an embodiment, a component, including without limitation the base (30), bracket (18), and/or mirrors (22) may be shaped, arranged, configured, or attached to another component differently than in the depicted embodiment, depending on the specific power tool (12) with which the optical aid (10) is meant to be used.

In an embodiment, the overall configuration and/or arrangement of the various components, including without limitation the base (30), bracket (18), and/or mirrors (22) will vary depending on the power tool (12) with which the optical aid (10) is intended to be used. It is specifically contemplated that this variance will exist among classes of tools and within a given class of tools. By the way of example and not limitation, in an embodiment suitable for use with a wood router (12), the shape of the base (30) may vary depending on the specific make and model of router (12) for which the optical aid (10) is designed.

By way of example and not limitation, wood routers (12) are typically operated by placing the router (12) flat on the work piece, gripping the handles of the router (12), and smoothly moving the router (12) across the work piece. In the depicted embodiment, the base (30) of the optical aid is generally flat, to facilitate the normal operation of the router (12) and smooth, to avoid damaging the work piece. The base (30) is generally made from rigid materials capable of withstanding the vibration of the router (12) motor, similar to those materials typically used to construct the router's (12) own base, including without limitation metals and metal alloys. The base (30) may be attached to the router (12) by use of hardware (not shown) or by some other means, so long as the attachment is sufficiently secure so that when the operator moves the router (12), the optical aid (10) moves with it and does not tend to become detached from the router (12). The base (30) may attach to the router's (12) existing base, or, in another embodiment, the optical aid (10) is configured to match the general design of the router's (12) existing base, and the optical aid (10) is attached to the router (12) by removing the router's (12) existing base and replacing it with the optical aid (10). In an embodiment, the base (30) may be shaped differently, be composed of different materials, or may be attached to the power tool (12) in a different manner, or have further different characteristics. In an embodiment, the optical aid (10) may not have a base at all.

In the depicted embodiment of FIG. 1, the optical aid (10) includes a bracket (28) attached to the top of the base (30). The depicted bracket (28) is generally U-shaped, with the trough of the “U” attached to the base (30) and the vertical sides of the bracket (28) generally perpendicular to the base (30). The bracket (28) is generally made from the same or similar materials as the base (30) and can be attached to the base (30) via any mechanism sufficiently secure to prevent significant movement of the bracket (28) independently of the base (30), and to withstand the vibrational force of the router (12) motor. Such materials include without limitation metals and metal alloys, and the attachment methods include, without limitation, welding and adhesives. The precise shape, size, and configuration of the bracket (28) may vary in an embodiment, and need only be sufficient for accepting one or more mirrors (22) disposed upon the bracket (28) so that the operator can view the cutting surface (14) in the mirrors (22) while using the power tool (12). In an embodiment, the optical aid (10) has more than one bracket (28). In an embodiment including more than one bracket (28), the brackets (28) may be of the same, similar, or different design, shape, material and/or configuration, depending on the particular power tool (12) with which the optical aid (10) is to be used.

In an embodiment, the mirrors (22) may pivot or rotate to accommodate the height and vantage point of the operator. In an embodiment, the mirrors (22) rotate directly. In another embodiment, the mirrors are adjusted by rotating another surface, including but not limited to a metal plate (20), to which the mirrors (22) are attached.

In the depicted embodiment, the mirrors (22) are generally rectangular in shape and affixed to metal plates (20), which are also generally rectangular in shape. In an embodiment, the mirrors (22) may be of any shape, the same shape, or different shapes. For purposes of this disclosure, the term mirrors (22) should be understand as referring to any reflective surface. In an embodiment, the mirrors (22) may be made of any material suitable for use in a reflective surface, including without limitation: glass, plastic, or polished metal. In an embodiment, the optical aid (10) has one mirror (22). In another embodiment, such as the depicted embodiment, the optical aid (10) has a plurality of mirrors (22). In an embodiment, a mirror (22) may magnify or reduce the reflected image. In an embodiment, a mirror (22) may have guide lines, guide rules, or other images affixed to or otherwise disposed upon it.

In the depicted embodiment, the metal plates (20) are generally rectangular and attached to the bracket (28) by threading a threaded rod (18) through a generally cylindrical hole lengthwise through the metal plate (20), and also threading the threaded rod (18) through similarly shaped and sized holes in the vertical sides of the bracket (28). The threaded rod (18) is then held in place by a nut (32) on one side, and a clamp (16) on the other. When the clamp (16) is in locked position, the threaded rod (18) does not rotate, and thus the metal plates (20) and mirrors (22) do not rotate, fixing the angle of the mirrors (22) to accommodate the height and vantage point of the operator. The angles of the mirrors (22) can be adjusted by unlocking the clamp (16), adjusting the angle of the metal plate (20), and then relocking the clamp (16).

The precise mechanism by which the metal plates (20) are attached to the optical aid (10) or the bracket (28), or by which the rotation of the metal plates (20) is accomplished, will necessarily vary depending upon the particular power tool (12) with which a given embodiment of the optical aid (10) is meant to be used. By way of example and not limitation, the metal plates (20) can be affixed to the bracket (28) by means other than hardware, including without limitation by tension mounting, magnetism, or adhesive. In an embodiment, zero, one, or a plurality of the metal plates (20) may be rotated. The rotation of the metal plates (20), including without limitation the mechanism to lock the metal plates in place, may be facilitated by use of hardware other than that depicted or without the use of hardware.

The metal plates (20) provide a rugged, rigid surface to facilitate rotation of the mirrors (22). The mirrors (22) may be made of fragile materials, such as glass, which crack or shatter under pressure. For example, if the operator attempts to rotate a glass mirror (22) but forgets to loosen the clamp (16), the mirror (22) may break. The metal plates (20) provide a supporting structure to allow rotation without risking damage to the mirrors (22). The metal plates (20) are also simpler to manufacture with holes bored for the threaded rod (18) than is a mirror (22). In an embodiment, the plates (20) are made from a material other than metal.

While in the depicted embodiments the mirrors (22) are attached to the bracket (28) via the metal plates (20), any mechanism for attaching the mirrors (22) to the bracket (28) is contemplated, including but not limited to, by use of other hardware or components not depicted in the figures, or by other mechanism not requiring the use of additional hardware or components, such as the use of an adhesive, magnetism, or tension. In an embodiment having a plurality of mirrors (22), the mirrors (22) may be attached in the same manner or by a different manner.

The precise arrangement of the metal plates (20), mirrors (22), bracket (28), and base (30) will vary depending on the power tool with which the optical aid (10) is to be used. The design need only be sufficient to permit the mirrors (22) to reflect to the operator an image of the cutting surface (14). In the embodiment depicted in FIGS. 1 and 3, the U-shape of the bracket (28) provides a void allowing light reflecting from the cutting surface (14) to reach one mirror (22), to reflect from that mirror (22) to a second mirror (22), and to reflect from the second mirror (22) to the operator, as depicted by the dashed lines. The configuration of the bracket (28) in a U-shape provides an unobstructed path for the light to reach each mirror. In an embodiment, the components may differ, or be arranged differently, to provide such an unobstructed path.

It is generally preferred that the mirrors (22) and other components be arranged and shaped so that the operator can operate the router (12) in a natural and comfortable posture similar to how the router (12) is operated without the use of the optical aid (10). For example, the arrangement and shape of the components, including without limitation the mirrors (22) and bracket (28), should be such that the operator can operate the router (12) while standing comfortably and holding his head at generally the same elevation and orientation with respect with the router (12) as when the operator uses the router (12) without the optical aid (10). This allows for superior control, improves safety, and improves quality of workmanship by taking advantage of muscle memory already developed by the operator and allowing the power tool's (12) safety features to be more fully utilized while also reducing strain on the operator.

Although the depicted embodiment shows the optical aid (10) in use with a wood router (12), the optical aid (10) may be used in conjunction with any type of power tool, whether for use with wood or another material, where the operator cannot otherwise directly observe the cutting surface (14). By way of example and not limitation, the present optical aid (10) may be configured for use with: a jigsaw, a scroll saw, a circular saw, a saber saw, a miter saw, a reciprocating saw, a drill, a torch, a sander, a pneumatic nailing device, a joiner, a planer, a grinder, or an impact driver.

In an embodiment, a light source (24) is attached to the bracket (28) such that the light source (24) illuminates the cutting surface (14) of the power tool (12). In an embodiment, the light source (24) may be attached to a component of the optical aid (10) other than the bracket (28), including without limitation components not depicted. In an embodiment, the light source (24) is powered by the same source of electricity that powers the tool (12). In another embodiment, the light source (24) is powered by a separate power source (26). In the depicted embodiment, the separate power source is a battery (26) attached to the bracket (28), but the separate power source may be affixed to any part of the optical aid (10). In an embodiment, the power source is other than a battery (24), including without limitation a solar cell. The battery (28) and light source (24) may be separate devices, or a single, self-contained device.

In an embodiment, the additional components or accessories may be attached to the optical aid (10), including but not limited to a chip guard (not depicted) and/or an edge guide (not depicted).

In an embodiment, the optical aid (10) attaches to the router (12) by attaching to the base plate or frame of the router (12). In another embodiment, the optical aid (10) attaches to the router (12) by replacing the router's (12) existing base plate. In such an embodiment, the portion of the optical aid (10) attaching to the router, for example, the base (30) or bracket (28), is shaped similarly to the existing base plate such that the hardware used to attach the existing base plate to the router (12) can be re-used to attach the optical aid (10) to the router (12), providing the same functions as the existing base plate with the additional functions of the present optical aid (10). In an embodiment, the optical aid (10) replaces an existing base, or other component, of a power tool other than a wood router (12).

In the depicted embodiment, the optical aid (10) reflects to the operator the image of the router bit (14), allowing the operator to use the router (12) for engraving projects not possible with a jig. For example, a pattern or template can be drawn directly on the work piece and the operator can follow the pattern or template free-hand by using the optical aid (10) to observe the router bit (14). This allows templates or patterns that are specific to one particular work piece or project, such as names, to be engraved using the power and precision of a wood router (12), without wasting time or stock constructing a single-use jig. The present optical aid (10) thus also allows the operator to engrave or carve patterns or designs which are difficult or impossible with an engraving jig, such as patterns or designs having closed shapes.

A pattern may be applied directly to the work piece by drawing, printing, scoring, or otherwise marking or impressing upon the work piece, or indirectly such as by printing or otherwise impressing the pattern upon another material which is then applied to the work piece. By way of example and not limitation, an engraving pattern may be printed on a sheet of paper which is then affixed to the work piece. After the operator uses the optical aid (10) to follow the pattern on the paper with the router (12) to apply the engraving, the paper is removed, leaving the engraving.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. An optical aid for a power tool, said optical aid comprising:
a power tool having a cutting surface;
an optical aid including:
a base configured for attaching to said power tool;
a bracket attached to said base;
one or more mirrors disposed on said bracket such that said one or more mirrors reflect to the operator of said power tool an image of said cutting surface.

2. The optical aid of claim 1, wherein said optical aid further includes a light source attached to said bracket and illuminating said cutting surface.

3. The optical aid of claim 1, wherein one or more of said one or more mirrors magnifies the reflected image.

4. The optical aid of claim 1, wherein said base attaches to an existing base of said power tool.

5. The optical aid of claim 1, wherein said base replaces an existing base of said power tool.

6. A method for making a power tool having an optical aid, said method comprising:
providing a power tool having a cutting surface and an existing base plate;
providing a new base plate configured for attaching to said power tool, said new base plate including:
a bracket attached to said new base plate;
one or more mirrors disposed on said bracket such that when said new base plate is attached to said power tool, said one or more mirrors reflect to the operator of said power tool an image of said cutting surface;
replacing said existing base plate with said new base plate;
making a power tool having an optical aid.

7. The method of claim 6, wherein said method further comprises:
providing a light source attached to said new base plate;
illuminating said cutting surface with said light source.

8. The method of claim 6, wherein one or more of said one or more mirrors magnifies the reflected image.

9. A method for viewing the cutting surface of a power tool, said method comprising:
providing a power tool having a cutting surface;
providing an optical aid for said power tool, said optical aid having one or more mirrors reflecting to the operator of said power tool an image of said cutting surface;
attaching said optical aid to said power tool;
viewing said cutting surface in one or more of said one or more mirrors.

10. The method of claim 9, said method further comprising:
said providing an optical aid further comprising:
a light source;
illuminating said cutting surface with said light source.
